(19) United States
(12) Patent Application Publication
(10) Pub. No.: US 2007/0022277 A1
(43) Pub. Date: Jan. 25, 2007

(54) Method and system for an enhanced microprocessor

(76) Inventors: Kenji Iwamura, Hachioji (JP); Takeki Osanai, Ebina (JP); Yukio Watanabe, Kawasaki (JP)

Correspondence Address: SPRINKLE IP LAW GROUP, 1301 W. 25TH STREET, SUITE 408, AUSTIN, TX, 78705, US

(21) Appl. No.: 11/185,462

(22) Filed: Jul. 20, 2005

(51) Int. Cl. G06F 9/40

(52) U.S. Cl. 712/229; 712/216

(57) ABSTRACT

Systems and methods for modes of operation for processing data are disclosed. While executing a program in one mode the hazard checking logic present in the microprocessor system may be utilized to check or ameliorate the hazards caused by the execution of this program. However, when a program does not need this hazard checking, the microprocessor may execute this program in a mode where some portion of the hazard checking logic of the microprocessor may not be utilized in conjunction with the execution of this program. This allows the higher speed execution of these types of programs by eliminating checking for dependencies, the detection of false load/store dependencies, the insertion of unnecessary stalls into the execution pipeline of the microprocessor or other hardware operations. Furthermore, by reducing the use of hazard detection logic a decrease in power consumption may also be effectuated.

### TECHNICAL FIELD OF THE INVENTION

The invention relates in general to methods and systems for microprocessors, and more particularly, to high-performance modes of operation for a microprocessor.

### BACKGROUND OF THE INVENTION

n recent years, there has been an insatiable desire for faster computer processing data throughputs because cutting-edge computer applications are becoming more and more complex. This complexity commensurately places ever increasing demands on microprocessing systems. The microprocessors in these systems have therefore been designed with hardware functionality intended to speed the execution of instructions.

One example of such functionality is a pipelined architecture. In a pipelined architecture instruction execution overlaps, so even though it might take five clock cycles to execute each instruction, there can be five instructions in various stages of execution simultaneously. That way it looks like one instruction completes every clock cycle.

Additionally, many modern processors have superscalar architectures. In these superscalar architectures, one or more stages of the instruction pipeline may be duplicated. For example, a microprocessor may have multiple instruction decoders, each with its own pipeline, allowing for multiple instruction streams, which means that more than one instruction can complete during each clock cycle.

Techniques of these types, however, may be quite difficult to implement. In particular, pipeline hazards may arise. Pipeline hazards are situations that prevent the next instruction in an instruction stream from executing during its designated clock cycle. In this case, the instruction is said to be stalled. When an instruction is stalled, typically all instructions following the stalled instruction are also stalled. While instructions preceding the stalled instruction can continue executing, no new instructions may be fetched during the stall.

Pipeline hazards, in main, consist of three main types. Structural hazards, data hazards and control hazards. Structural hazards occur when a certain processor resource, such as a portion of memory or a functional unit, is requested by more than one instruction in the pipeline. A data hazard is a result of data dependencies between instructions. For example, a data hazard may arise when two instructions are in the pipeline where one of the instructions needs a result produced by the other instruction. Thus, the execution of the first instruction must be stalled until the completion of the second instruction. Control hazards may arise as the result of the occurrence of a branch instruction. Instructions following the branch instruction must usually be stalled until it is determined which branch is to be taken.

In order to deal with these pipeline hazards, and other problems associated with pipelining, a number of hardware techniques have been implemented on modern day microprocessors. These hardware techniques check the various instructions in the pipeline, account for the dependencies between the instructions and resulting pipeline hazards to allow pipelining to be implemented on a microprocessor by accounting for these pipeline hazards.

Load/store dependency logic may exist in a processor to cope with structural hazards that arise from instructions accessing an identical memory location. For example, a load instruction accessing a certain data location may be present in the first stage of an execution pipeline, while a store instruction storing data to the same data location may be present in a downstream stage of the execution pipeline. Thus, the load instruction will not obtain the correct data unless the execution of the load instruction is postponed until the completion of the store instruction. The load/store dependency logic checks the instructions for dependencies of this type and accounts for these dependencies, for example by stalling the load instruction until the store to the address has completed.

Forwarding (also called bypassing and sometimes short-circuiting) is a hardware technique that tries to reduce performance penalties due to the data hazards introduced by the microprocessor pipeline. Instead of stalling the pipeline to avoid data hazards a data forwarding architecture may be used. More specifically, forwarding hardware can pass the results of previous instructions from one stage in the execution pipeline directly to an earlier stage in the pipeline that requires that result.

Typically, however, to utilize these techniques to account for pipeline hazards, logic must be included in the microprocessor to accomplish these tasks. For example, to implement forwarding the necessary forwarding paths and the related control logic must be included in the processor design. In general, this technique requires an interconnection topology and multiplexers to connect the outputs of one or more downstream pipeline stages to the inputs of one or more upstream stages in the execution pipeline of the microprocessor. To implement load/store dependency checking, in some cases comparators are included at many stages of the pipeline in order to compare the addresses of locations accessed by the various instructions in the pipeline.

These techniques, however, do not come without a price. The additional logic required to implement these techniques may slow the execution of instructions through the pipeline relative to execution of instructions which do not require the use of these techniques. Additionally, this logic may occasionally detect a hazard where none exists. For example, due to ever increasing demand for processing speed of the recent processors, address dependency detection logic may in many cases compare only the lower order bits of the addresses. The actual load/store operation, however, is done with the entire set of address bits. If address comparison is done only with the lower order bits of addresses, it can happen that two different addresses have a same combination of lower order bits and the address dependency detection logic falsely reports that the two addresses are the same. Based on this detected dependency the load/store dependency logic may unnecessarily stall the pipeline.

Some software, however, may be optimized for a particular piece of hardware, and may not require this hazard detection logic. For example, to insure high-speed execution and maximum performance in many cases, software designed to run on a digital signal processor may be highly optimized to the hardware of the specific digital signal processor. To avoid degradation of execution frequency of a typical digital signal processor, these digital signal processors do not include dependency checking logic. Thus, software optimized for these types of digital signal processors are usually written to not have pipeline hazards, either by proper scheduling of instructions or by some other methodology. If such software is not optimized in this manner it may create an error when running on a digital signal processor of this type.

As the speed of microprocessors continues to rise, it is increasingly desirable to execute this type of digital signal processing (DSP) functionality on the main microprocessor in a microprocessing system, eliminating the need for separate DSP hardware. By utilizing the hardware already present in a typical high-speed microprocessing system to implement DSP, a higher-performance lower-power system can be achieved. However, when executing this type of optimized software on a typical microprocessor the hazard detection logic present in the microprocessor may slow the execution of the DSP functionality relative to the execution of the DSP instructions without checking for these hazards. As most DSP software has been designed, written or optimized specifically not to create these types of pipeline hazards, this checking may be superfluous.

Thus, a need exists for systems and methods for processing data which include modes of operation suitable for efficient processing of different types of software, such as system controllers and data processing.

### SUMMARY OF THE INVENTION

Systems and methods for modes of operation for processing, data are disclosed. While executing a program in one mode the hazard checking logic present in the microprocessor system may be utilized to check or ameliorate the hazards caused by the execution of this program. However, when a program does not need this hazard checking, the microprocessor may execute this program in a mode where some portion of the hazard checking logic of the microprocessor may not be utilized in conjunction with the execution of this program. This allows the higher speed execution of these types of programs by eliminating checking for dependencies, the detection of false load/store dependencies, the insertion of unnecessary stalls into the execution pipeline of the microprocessor or other hardware operations.

In one embodiment, a microprocessor has a set of mode bits which indicate the mode of a microprocessor. When the set of bits indicate the microprocessor is in one state the microprocessor executes instructions using the hazard detection logic. However, when the set of mode bits indicate that is another state the microprocessor executes instructions without the hazard detection logic.

In another embodiment, this hazard detection logic may be powered off when the set of mode bits is in the second state.

In one embodiment, the state of the set of bits is set by an instruction.

In another embodiment, the instruction can also have “sync” effect so that program contexts can be separated between before and after a state change.

Embodiments of the present invention may provide the technical advantage of the execution of optimized programs without the degradation of the execution frequency caused by the detection of false load/store dependencies, and unnecessary pipeline stalls. Additionally, these programs may be executed using less power as dependency detection logic or forwarding logic may not be utilized when executing these programs.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a block diagram of one embodiment of a microprocessor.

FIG. 2 depicts a block diagram of one embodiment of a pipeline of a microprocessor.

FIG. 3 depicts a block diagram of one embodiment of a microprocessor.

FIG. 4 depicts a block diagram of one embodiment of load/store logic.

FIG. 5 depicts a block diagram of one embodiment of a pipeline of a microprocessor.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

Reference is now made in detail to the exemplary embodiments of the invention, examples of which are illustrated in the accompanying drawings. Wherever possible, the same reference numbers will be used throughout the drawings to refer to the same or like parts (elements).

Initially, a few terms are defined or clarified to aid in an understanding of the terms as used throughout the specification. The terms “hazard detection logic” and “dependency detection logic” are intended to mean any software, hardware or combination of the two which checks, finds, ameliorates, speeds or otherwise involves the interrelation of instructions in one or more instruction pipelines of a microprocessor.

The term “DSP mode” is intended to mean any mode of operation in which any portion of a hazard checking mechanism of a microprocessor is not utilized, and should not be taken to specifically refer to the execution of instructions pertaining to DSP on a microprocessor.

The term “normal mode” is intended to mean a mode of operation of a microprocessor in which the hazard checking logic of a microprocessor is substantially entirely utilized.

Attention is now directed to systems and methods for modes of operation for processing data. One or more of these modes may alleviate the desire to process software programs such as DSP programs on stand alone processors by allowing high-performance execution of these software programs on a microprocessing system. While executing a typical microprocessor program in one mode the hazard checking logic present in the microprocessor system may be utilized to check or ameliorate the hazards caused by the execution of this program. However, when a program does not need this hazard checking, the microprocessor may execute this program in a mode where some portion of the hazard checking logic of the microprocessor may not be utilized in conjunction with the execution of this program. This allows the higher speed execution of these types of programs by eliminating checking for dependencies, the detection of false load/store dependencies, the insertion of unnecessary stalls into the execution pipeline of the microprocessor or other hardware operations. Furthermore, by reducing the use of hazard detection logic a decrease in power consumption may also be effectuated.

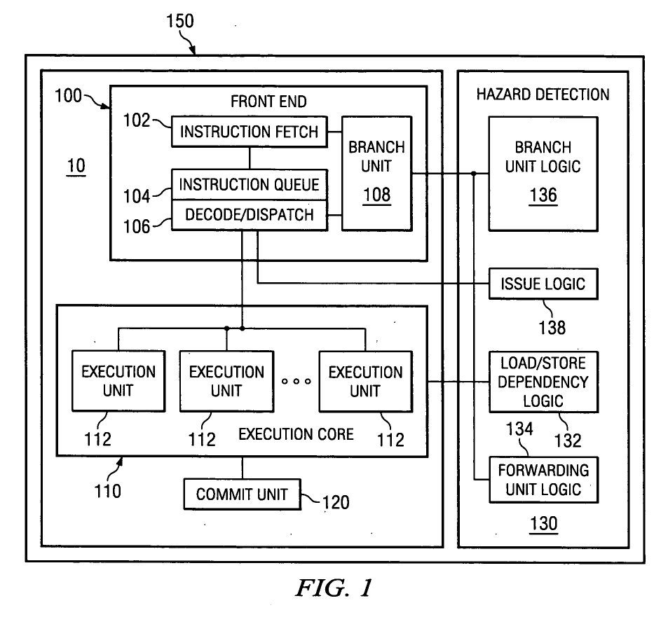

An exemplary microprocessor pipeline architecture for use in illustrating embodiments of the present invention is depicted in FIG. 1. It will be apparent to those of skill in the art that this is a simple architecture intended for illustrative embodiments only, and that the systems and methods described herein may be employed with any variety of more complicated or simpler architectures in a wide variety of microprocessing systems, including those with a wider or lesser degree of hazard detection.

It will also be apparent that though the terminology used may be specific to a particular microprocessor architecture, the functionality referred to with this terminology may be substantially similar to the functionality in other microprocessor architectures.

Microprocessor 150 may include pipeline 10 which, in turn, may include front end 100, execution core 110, commit unit 120. Microprocessor 150 may also include hazard detection logic 130 coupled to pipeline 10. Front end 100, in turn, includes fetch unit 102, instruction queue 104, decode/dispatch unit 106 and branch processing unit 108. Front end 100 may supply instructions to instruction queue 104 by accessing an instruction cache using the address of the next instruction or an address supplied by branch processing unit 108 when a branch is predicted or resolved. Front end 100 may fetch four sequential instructions from an instruction cache and provide these instructions to an eight entry instruction queue 104.

Instructions from instruction queue 104 are decoded and dispatched to the appropriate execution unit by decode/dispatch unit 106. In many cases, decode/dispatch unit 106 provides the logic for decoding instructions and issuing them to the appropriate execution unit 112. In one particular embodiment, an eight entry instruction queue 104 consists of two four entry queues, a decode queue and a dispatch queue. Decode logic of decode/dispatch unit 106 decodes the four instruction in the decode queue, while the dispatch logic of decode/dispatch unit 106 evaluates the instructions in the dispatch queue for possible dispatch, and allocates instructions to the appropriate execution unit 112.

Execution units 112 are responsible for the execution of different types of instruction issued from dispatch logic of decode/dispatch unit 106. Execution units 112 may include a series of arithmetic execution units, including scalar arithmetic logic units and vector arithmetic logic units. Scalar arithmetic units may include single cycle integer units responsible for executing integer instructions and floating point units responsible for executing single and double precision floating point operations. Execution units 112 may also include a load/store execution unit operable to transfer data between a cache and a results bus, route data to other execution units, and transfer data to and from system memory. The load/store unit may also support cache control instructions and load/store instructions. Thus, each of execution units 112 may contains one or more execution stages in pipeline 10 of microprocessor 150.

Commit unit 120 may receive instructions from execution units 112 in execution core 110, and is responsible for assembling the incoming instructions in the order in which they were issued and writing the results of the instructions back to a location if necessary.

During a normal mode of operation of microprocessor 150, each issued instruction may flow through one particular execution unit 112 in execution core 110. This may consist of an instruction being fetched by front end 100 and placed in instruction queue 104. Instructions from this instruction queue 104 are then decoded and dispatched to the proper execution unit 112. The instruction may proceed through the pipelined stages of the execution unit 112. The results of the instruction are eventually written back at commit stage 120.

Additionally, during the normal mode of operation of microprocessor 150, hazard detection logic 130 may be utilized in conjunction with the processing of instructions to analyze the instructions in one or more execution units 112 of pipeline 10 of microprocessor 150 to determine pipeline hazards which may result from the processing of these instructions, adjust for these dependencies, or ameliorate delays caused by these dependencies. In one embodiment, hazard detection logic 130 may contain issue logic 138, load/store dependency logic 132, forwarding unit logic 134 and branch unit logic 136. It will be understood that any or all of the logic depicted with respect to hazard detection logic 130 may be contained in any part of front end 110, execution core 120 or commit unit 130 or any other portion of microprocessor 150, that hazard detection logic 130 may contain lesser, different, or greater types of logic than depicted in FIG. 1, and the arrangement depicted in FIG. 1 is for descriptive purposes only.

Load/store dependency logic 132 is operable to check for instructions which may create structural or other pipeline hazards and deal with these hazards, for example, by placing no-ops in pipeline 10, as is known in the art. Load/store dependency logic 132 may analyze the instructions in pipeline 10 by comparing the operator or operand addresses of the instructions in the pipeline to see if any addresses contained by the instructions in the pipeline are substantially identical. Load/store dependency logic 132 is therefore operable to detect an address dependency between a load instruction issued in close proximity to a preceding store instruction, where the load instruction and the store instruction both reference a data location which has at least a portion of an identical address. Load/store dependency logic 132 may also be operable to detect dependencies between any other memory access commands in the pipeline, such as two load instructions, a cache refill and a succeeding load etc.

In one embodiment, target register information in pipeline 10, and the source register information of instructions to be issued are given to load/store dependency logic 132. Load/store dependency logic 132 may generate control signals to both of issue logic 138 and forwarding unit 134.

Forwarding unit 134 may be operable to deal with data hazards that arise in pipeline 10 by forwarding the results which occur at one stage of an execution unit 112 of pipeline 10 directly to another stage of an execution unit 112 of pipeline 10 before storing that result back to memory, as is known in the art. Forwarding unit 134 may have logic operable to forward the results of an operation at one stage in an execution unit 112 of pipeline 10 to any other stage of an execution unit 112 in pipeline 10, or may have logic to forward the results that occur at a certain stage of an execution unit 112 of pipeline 10 to other stages of an execution unit 112 of pipeline 10 depending on the particular implementation of forwarding unit 134 or pipeline 10.

Branch unit logic 136 may be responsible for dealing with control hazards that may arise as the result of the occurrence of a branch instruction. Branch unit logic 136 may be responsible for dealing with stalling instructions following a branch instruction. In one embodiment, branch unit logic 136 works in conjunction with branch unit 108 to insert one or more no-ops into pipeline 10 as is known in the art.

Issue logic 138 may be used in conjunction with decode/dispatch block 106 to determine the order in which instructions are issued to execution units 112, and to which execution unit 112 each instruction is issued. This may be done, in part, based on a register or registers accessed by the various instructions in instruction queue 104 and the target register or registers of instructions in pipeline 10. Additionally, issue logic 138 may use control signals from load/store dependency logic 132 to determine which instructions to issue.

Thus, during a normal mode of operation of microprocessor 150, hazard detection logic 130 may function to deal with pipeline hazards that arise in pipeline 10 as a result of the processing of instructions of a software program. Additionally, hazard detection logic 130 may be operable to forward data directly from one stage of an execution unit 112 of pipeline 10 to another stage of a pipe of pipeline 10.

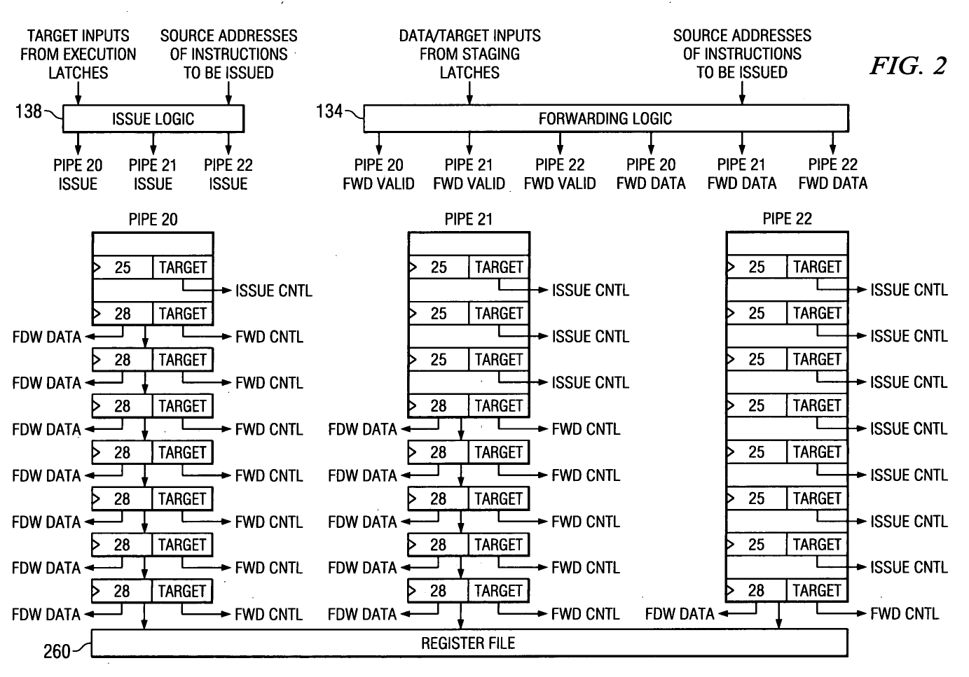

FIG. 2 depicts an example of the overhead imposed by this hazard detection logic. Assume pipeline 10 contains pipelined execution units 20, 21, 22. Each pipelined execution unit 20, 21, 22 contains execution stages 25 and staging latches 28. Instructions proceed through execution stages 25 of each pipelined execution unit 20, 21, 22. The results of the instruction are then placed in staging latches 28 for eventual commit to register file 260. In order to check for dependency between instructions that are to be issued and instructions in pipelined execution units 20, 21, 22, target addresses within execution stages 25 may be checked against instructions to be issued by issue logic 138. In this case, if the depth of a pipelined execution unit 20, 21, 22 is larger, it becomes more difficult to detect the dependency in one clock cycle of microprocessor 150. Additionally to forward the results of an instruction, the results in staging latches 28 may be given to forwarding logic 134 and the data actually needed by succeeding instructions may be chosen based on the target address information in staging latches 28. If there is a pipelined execution unit 20, 21, 22 which has relatively more staging latches 28, in this example pipelined execution unit 20, than other pipelined execution units 21, 22, the overhead required for forwarding may become exponentially larger and it becomes difficult to handle the forwarding in one cycle.

One solution to solve this problem is to prevent instruction issue while any instruction is in the first several stages of the pipelined execution units 20, 21, 22 with more execution stages 25. For example, if an instruction is under execution in the first 4 execution stages 25 of pipelined execution unit 22, issue control 138 may stop issuing any new instructions. By doing this, the number of the target addresses that issue control 138 compares is reduced, and the number of the staging latches 28 communicating with forwarding logic 134 is also reduced. As can be seen, this methodology may cause a severe performance degradation.

However, as explained above, some software programs may be designed specifically not to generate pipeline hazards. As hazard detection logic 130 may be superfluous when executing software programs of this type, it may be desirable to disable one or more sections of hazard detection logic 130 during execution of these software programs to speed the execution of these software programs and simultaneously reduce the power consumed by microprocessor 150 while executing these software programs.

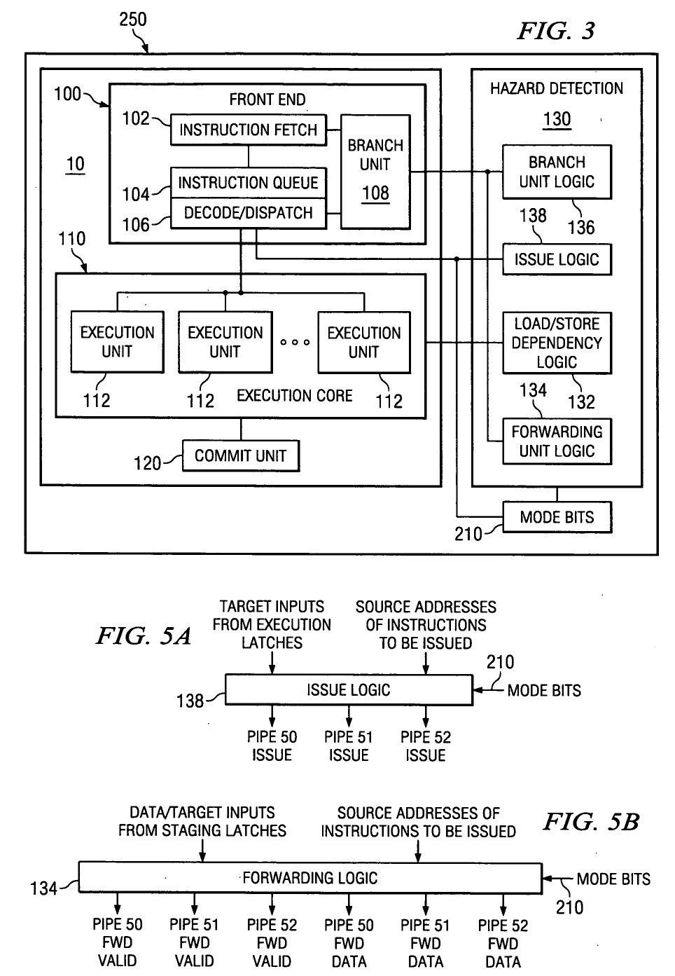

To accomplish this, it may be desirable to operate microprocessor 150 without utilizing hazard detection logic 130 when processing a program. To accomplish this it would be helpful to be able to disable, gate off, halt or power down one or more sections of hazard detection logic 130 during another mode of operation. FIG. 3 depicts one embodiment of a microprocessor operable to function normally in one mode and without one or more sections of hazard detection circuitry in another mode. In one embodiment, microprocessor 250 includes one or more mode bits 210. These mode bits 210 indicate a mode of operation for microprocessor 250. When mode bits 210 are in one state, microprocessor 250 may function utilizing hazard detection logic 130 as described above with respect to FIG. 1. However, by setting one or more mode bits 210 to another state one or more portions of hazard logic 130 can be gated off from one or more portions of pipeline 10 such that microprocessor 250 executes instructions without that section of hazard detection logic 130.

Mode bits 210 may be set by an instruction issued from dispatch logic of decode/dispatch unit 106. This instruction may be part of the instruction set architecture of microprocessor 250 and have the added effect that it ensures that previously issued instructions have completed before mode bits 210 are set and before subsequent instructions are executed (known as the “sync” effect in some architectures). This functionality may be accomplished without forcing a flush of prefetched instructions in instruction queue 104.

In one embodiment, the state of the set of mode bits 210 may be determined by a location of a memory page of the microprocessor 250 that the microprocessor instructions are fetched from or by a location of a memory page of the microprocessor 250 that the microprocessor instructions make load/store accesses to.

Instructions of the microprocessor 250 may be categorized into two or more types, and the state of the set of mode bits 210 may be determined by the type of instruction executing on the microprocessor 250. Instruction types that enforce the microprocessor 250 to execute in “DSP mode” shall be called DSP instructions.

Additionally, mode bits 210 may be in a memory mapped register and may be set by writing to this register. This register may be written to by an instruction issued by microprocessor 250 or by an external controller through, for example a scan mechanism or a boundary-scan (JTAG) controller.

In a system that supports multiple program stream threads running substantially simultaneously, mode bits 210 may be set independently by each thread that may be executing on microprocessor 250, or may be configurable at boot time, or when an instruction issued from dispatch logic of decode/dispatch unit 106 references a specific area or page of a memory accessible by microprocessor 250 which is utilized to store programs optimized to alleviate pipeline hazards.

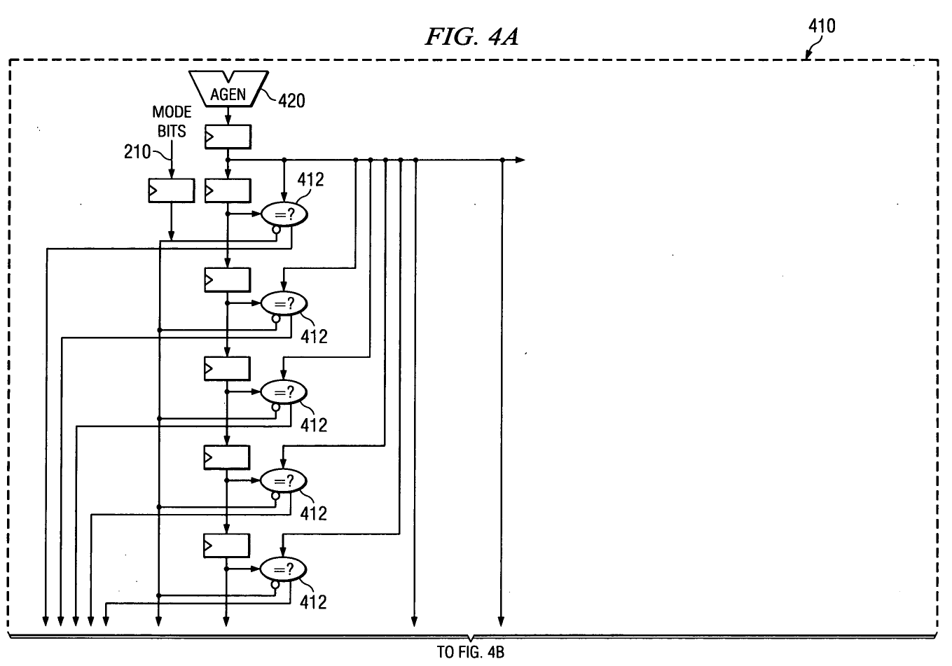

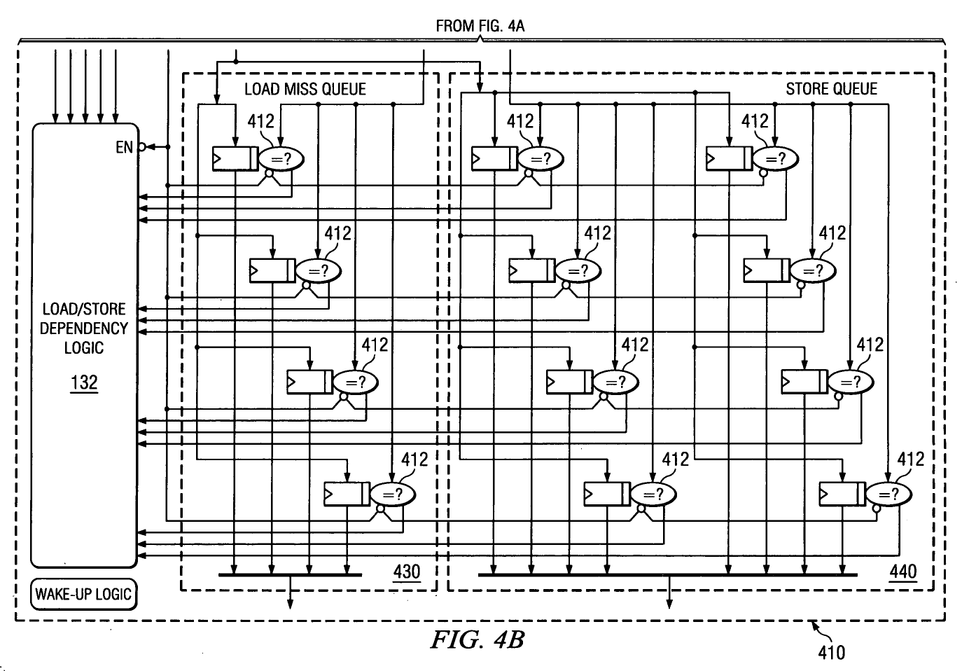

Turning to FIG. 4, an illustration of one embodiment of load/store dependency logic utilized in a microprocessor with modes of operation like that depicted in FIG. 3 is shown. Load/store logic 132 is coupled to mode bits 210 which indicate the mode of operation of a microprocessor.

Load/store unit 410 may generate an address for access into a memory using address generation logic 420. This address may be placed in a memory transaction pipeline and eventually placed in load miss queue 430 or store queue 440 for eventual dispatch to the memory, where the data referred to by the address will be loaded, or the location referenced by the address will be written to. Comparators 412 may compare the addresses referenced by instructions in memory transaction pipeline, load miss queue 430 and store queue 440. Load/store dependency logic 132 is also coupled to comparators 412.

In one embodiment, when no mode bits 210 are set, indicating that the microprocessor is in a normal mode, load/store dependency logic 132 may receive the output of comparators 412 and determine if there is a dependency between one or more of the instructions in the load/store pipeline, load miss queue 430 or store queue 440. If a dependency is detected by load/store dependency logic 132, no-ops may be inserted into the load/store pipeline, load miss queue 430 or store queue 440 as is known in the art.

If, however, one or more of mode bits 210 is set to indicate that the microprocessor is in a mode for processing optimized programs, comparators 412 may be disabled such that load/store dependency logic 132 is gated off from load/store unit 410, receives no output from comparators 412, or comparators 412 are inactive. In this manner, load/store dependency logic 132 may no longer detect dependencies in load/store unit 410 and therefore no no-ops are inserted into memory transaction pipeline, load/miss queue 430 or store queue 440. This may improve the performance of microprocessor 250, without increasing the operating frequency of microprocessor 250. Additionally, in one embodiment, if mode bits 210 indicate that the microprocessor is in a mode for processing optimized programs, load/store dependency logic 132 may be powered down such that power dissipation caused by activity of load store dependency logic 132 may be reduced.

Though FIG. 2 depicts the operation of load store dependency logic 132 with respect to mode bits 210, it will be apparent to those of skill in the art that in a similar manner other portions of microprocessor 250 may operate in conjunction with mode bits 210 in a similar manner. For example, when mode bits 210 indicate that microprocessor 210 is in a normal mode, forwarding logic 134 and branch logic 136 may operate with microprocessor 250 as is known in the art. However, when mode bits 210 indicate that the microprocessor is in a mode for processing optimized programs forwarding logic 134 and branch unit 136 may similarly be gated off from portions of microprocessor 250 and/or disabled such that they are not utilized, which may lead to increased performance of microprocessor 250 coupled with lower power consumption.

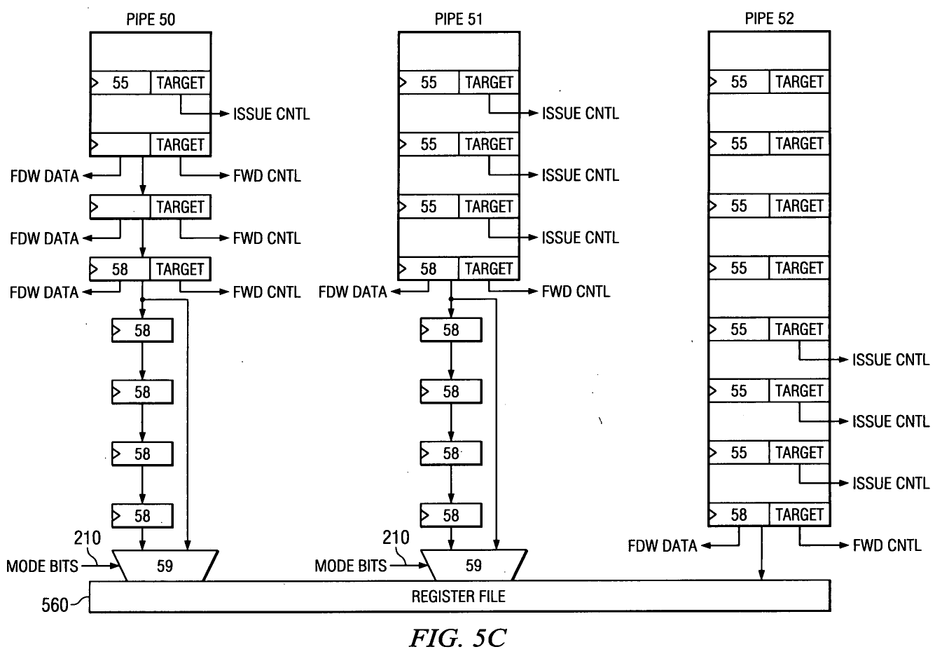

Turning to FIG. 5, an illustration of one embodiment of the interrelationship of portions of hazard detection logic with the pipeline of a microprocessor is depicted. Assume a microprocessor contains three pipelined execution units 50, 51, 52 as depicted. Each pipelined execution unit 50, 51, 52 contains execution stages 55 and staging latches 58. Pipelined execution units 50, 51 may have fewer execution stages 55 than longest pipelined execution unit 52 and additionally are coupled to multiplexers 59. The output of multiplexers 59 may, in turn, be selected by mode bits 210. Issue logic 132 and forwarding logic 134 may also be coupled to mode bits 210.

When mode bits 210 indicate that microprocessor 250 is executing in a normal mode-of operation, the data flow through pipelined execution units 50, 51, and 52 may be like that described with respect to FIG. 2. If however, mode bits 210 indicate that the microprocessor is in a mode for processing optimized programs forwarding logic 134 may be shutoff and the dependency checking portion of issue logic 132 may also shutoff. In this case, any instructions fetched from memory will be issued without stalling by issue checking portion of issue logic 132 and the result from forwarding logic 134 will not be used. Consequently, the output of muxes 59 may be switched based on mode bits to be taken from the first staging latch 58 of the respective pipelined execution unit 50, 51 associated with the mux 59. Thus, the data in the first staging latch 58 of the respective pipelined execution unit 50, 51 is written to register file 560, without having to proceed through the remainder of the staging latches 58 in the pipelined execution unit 50, 51.

The practical effects of the differences between the two modes of operation of microprocessor 250 may be illustrated more clearly with respect to a specific example. Suppose the following set of instructions are to be executed on pipelined execution unit 52 of a microprocessor with pipelined execution units 50, 51, 52 like those depicted in FIG. 5:
Instpipe52 $2, $1, $0 ($2 is target and $1 and $0 are sources)
Instpipe52 $5, $4, $3
Instpipe52 $6, $1, $3
Instpipe52 $7, $4, $0

With the microprocessor executing normally, each of these instructions may be executed according to the following schedule. In this example, it's assumed that the data dependency detection logic is not checking the first four stages of the pipeline, so four cycles of safe margin are utilized for issuing each succeeding instruction:
Cyc0 Instpipe52 $2, $1, $0
Cyc1
Cyc2
Cyc3
Cyc4
Cyc5 Instpipe52 $5, $4, $3
Cyc6
Cyc7
Cyc8
Cyc9
Cyc10 Instpipe52 $6, $1, $3
Cyc11
Cyc12
Cyc13
Cyc14
Cyc15 Instpipe52 $7, $4, $0

However, with the microprocessor in DSP mode, in which the data dependency detection is disabled, these instructions may be issued and executed with no delays:
Cyc0 Instpipe52 $2, $1, $0
Cyc1 Instpipe52 $5, $4, $3
Cyc2 Instpipe52 $6, $1, $3
Cyc3 Instpipe52 $7, $4, $0

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A system for efficient execution of optimized programs, comprising:
a microprocessor, wherein the microprocessor includes:
a set of mode bits; and
hazard detection logic comprising dependency detection logic operable to detect dependencies between a set of instructions, wherein when the set of mode bits is in a first state the microprocessor functions in conjunction with the hazard detection logic and when the set of mode bits is in a second state the microprocessor functions without the hazard detection logic.

2. The system of claim 1, wherein the dependency detection logic is further operable to be powered off when the set of mode bits is in the second state.

3. The system of claim 1, wherein the microprocessor runs at a first execution frequency when the set of mode bits is in the first state and a second execution frequency when the set of mode bits is in a second state.

4. The system of claim 1, wherein the set of mode bits is operable to be configured by an instruction.

5. The system of claim 4, wherein the instruction has sync functionality.

6. The system of claim 1, wherein the state of the set of the mode bits is determined by a location of a memory page from which the microprocessor instructions are fetched, by a location of a memory page to which the microprocessor instructions makes load/store accesses or by a type of instruction executing on the microprocessor.

7. The system of claim 1, wherein the set of mode bits is operable to be configured through a processor to processor communication port, scan mechanism, or JTAG controller.

8. The system of claim 1, further comprising a register, wherein the register comprises the set of mode bits.

9. The system of claim 8, wherein the register is a memory mapped register operable to be configured by writing to the memory mapped register.

10. The system of claim 1, wherein the system is operable to execute a set of threads, and the set of mode bits is operable to be configured by one or more of the set of threads.

11. The system of claim 1, wherein the dependency detection logic includes address dependency logic operable to compare a set of addresses referenced by instructions in the set of instructions.

12. The system of claim 11, wherein the address dependency logic is operable to be gated off when the set of mode bits is in the second state.

13. The system of claim 1, wherein the hazard detection logic further includes forwarding logic wherein the microprocessor functions in conjunction with the forwarding logic when the set of mode bits is in a first state and the microprocessor functions without the forwarding logic when the set of mode bits is in a second state.

14. The system of claim 13, wherein the forwarding logic is further operable to be powered off when the set of mode bits is in the second state.

15. The system of claim 1, wherein the hazard detection logic further includes stall logic wherein the microprocessor functions in conjunction with the stall logic when the set of mode bits is in a first state and the microprocessor functions without the stall logic when the set of mode bits is in a second state.

16. The system of claim 15, wherein the stall logic is further operable to be powered off when the set of mode bits is in the second state.

17. A method for efficient execution of optimized programs, comprising:
operating a microprocessor in conjunction with hazard detection logic when a set of mode bits is in a first state, wherein the hazard detection logic includes dependency detection logic; and
operating the microprocessor without the hazard detection logic when the set of mode bits is in a second state.

18. The method of claim 17, powering off the dependency detection logic if the set of mode bits is in the second state.

19. The method of claim 17, further comprising operating the microprocessor in a first execution frequency when the set of mode bits is in the first state and a second execution frequency when the set of mode bits is in the second state.

20. The method of claim 17, configuring the set of mode bits with an instruction.

21. The method of claim 20, wherein the instruction has sync functionality.

22. The method of claim 17,wherein the state of the set of the mode bits is determined by a location of a memory page from which the microprocessor instructions are fetched, by a location of a memory page to which the microprocessor instructions make load/store accesses or by a type of instruction executing on the microprocessor.

23. The method of claim 17, configuring the set of mode bits through a processor to processor communication port, scan mechanism, or JTAG controller.

24. The method of claim 17, wherein the set of mode bits are in a register.

25. The method of claim 24, writing to the register, wherein the memory mapped register.

26. The method of claim 17, executing a set of threads on the microprocessor and configuring the set of mode bits using one or more of the set of threads.

27. The method of claim 17, further comprising comparing a set of addresses referenced by instructions in the set of instructions, wherein the dependency detection logic includes address dependency logic and the comparing of the set of address is done by address dependency logic.

28. The method of claim 27, gating off the address dependency logic when the set of mode bits is in the second state.

29. The method of claim 17, wherein the hazard detection logic further includes forwarding logic.

30. The method of claim 30, further comprising powering off the forwarding logic when the set of mode bits is in the second state.

31. The method of claim 17, wherein the hazard detection logic further includes stall logic.

32. The method of claim 30, further comprising powering off the stall logic when the set of mode bits is in the second state.

33. A system for efficient execution of optimized programs, comprising:
a microprocessor, wherein the microprocessor includes:
a register comprising a set of mode bits; and
hazard detection logic comprising dependency detection logic operable to detect dependencies between a set of instructions and forwarding logic, wherein when the set of mode bits is in a first state the microprocessor functions in conjunction with the hazard detection logic and when the set of mode bits is in a second state the microprocessor functions without the hazard detection logic and the hazard detection logic is powered off.
